(19) United States
(12) Patent Application Publication
(10) Pub. No.: US 2011/0110029 A1
(43) Pub. Date: May 12, 2011

(54) Dedicated Air Inlets And Outlets For Computer Chassis Chambers

(76) Inventors: Ashwin V. Lodhia, Mountain View, CA (US); Thomas H. Szolyga, Saratoga, CA (US); Mark C. Solomon, Corvallis, OR (US)

(21) Appl. No.: 13/002,766

(22) PCT Filed: Jul. 9, 2008
(86) PCT No.: PCT/US08/69472

§ 371 Date: Jan. 5, 2011

(51) Int. Cl. G06F 1/20; G06F 1/16

(52) U.S. Cl. 361/679.47; 361/679.46; 361/679.31

(57) ABSTRACT

A computer chassis comprises a plurality of chambers. Each of the chambers comprises a hardware group, an aft inlet exposed to air external to the chassis and dedicated to the chamber, and an air outlet exposed to air external to the chassis and dedicated to the chamber. Airflow between the air net and the air outlet cools the hardware group.

### BACKGROUND

Computers comprise circuitry and other hardware that generates heat. For example, a computer may include various types of processors that function at high speeds and, as a result, emit substantial amounts of heat. High temperatures within a computer chassis may be detrimental to circuitry and other hardware within the chassis.

### BRIEF DESCRIPTION OF THE DRAWINGS

For a detailed description of exemplary embodiments of the invention, reference will now be made to the accompanying drawings in which:

FIG. 1 shows an illustrative desktop computer implementing an embodiment of the invention;

FIG. 2 shows another view of an illustrative desktop computer implementing an embodiment of the invention;

FIG. 3 shows a three-dimensional posterior view of the computer of FIG. 2, in accordance with an embodiment of the invention;

FIG. 4 shows a three-dimensional side view of the computer of FIG. 2, in accordance with an embodiment of the invention;

FIG. 5 shows a detailed view of the chassis of the computer of FIG. 2, in accordance with an embodiment of the invention;

FIG. 6 shows a conceptual illustration of the computer of FIG. 2 in operation, in accordance with an embodiment of the invention; and

FIG. 7 shows a dual liquid cooling/air cooling system implemented in the chassis of FIGS. 1-6, in accordance with an embodiment of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Further, when an air inlet, an air outlet or airflow is described as being “dedicated” to a chamber, it is meant that that air inlet, air outlet or airflow provides ventilation only, or mostly, for the chamber to which it is dedicated.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

An embodiment of the invention partitions heat-generating hardware (e.g., circuitry, power supplies) within a computer chassis into groups. Each of the groups is separated from the other groups by one or more dividers, so as to form chambers. Each chamber, along with the hardware group corresponding to that chamber, is cooled using a ventilation system dedicated to that group. In this way, heat generated by one group of hardware does not spread (or spreads to a lesser degree) to hardware in other groups, but is instead evacuated using that group's dedicated ventilation system.

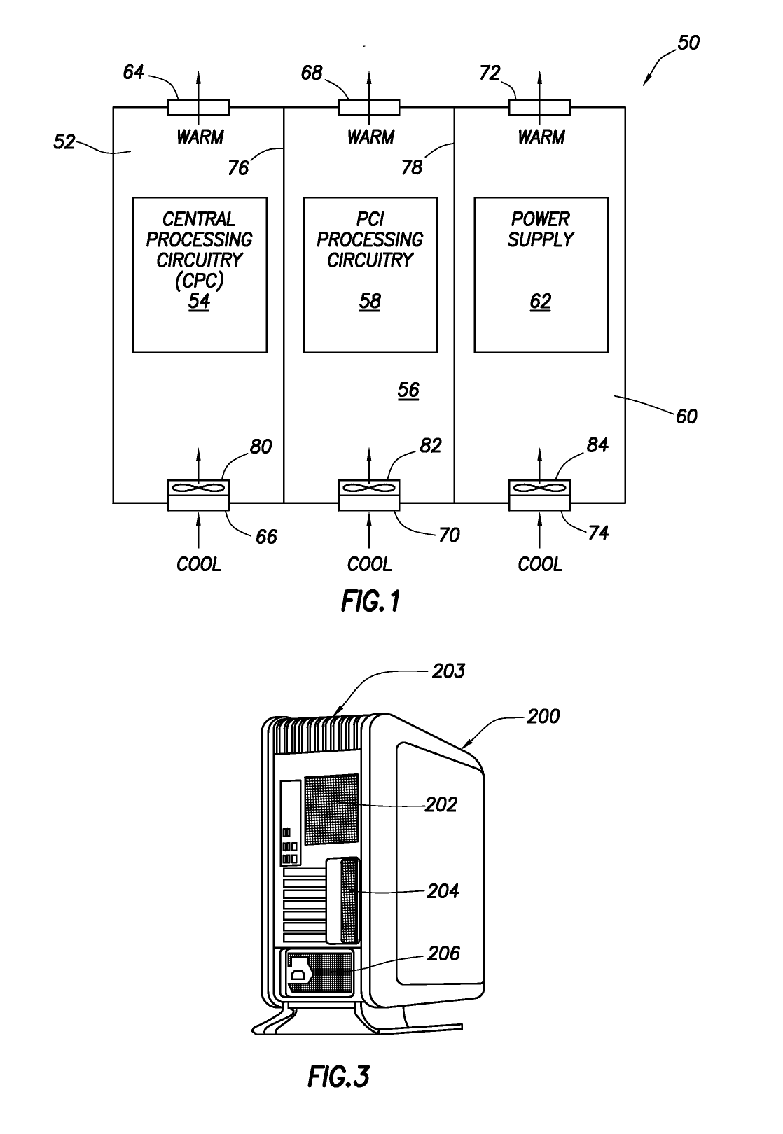

FIG. 1 shows an illustrative computer chassis 50. The computer chassis 50 may be part of a desktop computer system, a notebook or laptop computer system, a personal digital assistant (PDA), a mobile communication device (e.g., a cell phone), a digital music player, multimedia electronic devices (e.g., televisions), etc. The computer chassis 50 comprises various types of hardware, including central processing circuitry, or “CPC,” 54 (e.g., central processing unit (CPU), random access memory (RAM)), peripheral component interface (PC) processing circuitry 58 (e.g., PCI-based circuitry, physics cards, graphics processing circuitry (GPC) such as graphics cards), and a power supply 62. The CPC 54 is housed within a CPC chamber 52. The PCI circuitry 58 is housed within a PCI chamber 56. The power supply 62 is housed within a power supply chamber 60.

A divider 76 separates the CPC chamber 52 from the PCI chamber 56, while a divider 78 separates the PCI chamber 56 from the power supply chamber 60. Although the dividers 76 and 78 are said to separate these chambers, the dividers 76 and 78 also form the chambers, because each divider constitutes a common well shared by multiple chambers. In some embodiments, the dividers 76 and 78 are airtight, so that air does not pass between chambers. In other embodiments, the dividers 76 and 78 allow some air to pass between chambers. Stated in another way, in some embodiments, the dividers' dimensions extend across all or most of cross-sectional slices of the chassis, such that the chambers are completely or almost completely separated from each other. In some embodiments, one or more of the dividers may be of a size such that the divider(s) make contact with three or more sides of the chassis wall. Dividers shown in the figures and described herein may be composed of any suitable material(s), including plastics, metals, etc. Shapes of the dividers may be adapted as necessary for the electronic device in which the dividers are implemented. In some embodiments, the dividers may be flat, while in other embodiments, the dividers may have a curved shape (e.g., to facilitate aerodynamic airflow).

Although at least some of the embodiments disclosed herein describe the dividers as separating central processing circuitry, PCI-based processing circuitry and a power supply (or supplies), in some embodiments, the dividers may separate other types of circuitry. The separating technique disclosed herein may be implemented in various types of electronic devices and, therefore, may be adapted as desired.

The CPC chamber 52 comprises a CPC chamber inlet 66 and a CPC chamber outlet 64. The CPC chamber 52 may further comprise one or more fans 80 that create a negative pressure differential between the CPC chamber 52 and the air outside of the computer chassis 50. This negative pressure differential causes cool or ambient external air to pass through the CPC chamber inlet 66 and into the CPC chamber 52. The air is warmed by the CPC 54, thereby cooling the CPC 54. The warm air exits the CPC chamber 52 via the CPC chamber outlet 64. Similarly, the PCI chamber 56 comprises one or more fans 82, a PCI chamber inlet 70 and a PCI chamber outlet 68. Cool air enters the PCI chamber 56 via the PCI chamber inlet 70, collects heat from the PCI circuitry 58, and exits the PCI chamber 56 via the PCI chamber outlet 68. Likewise, the power supply chamber 60 comprises one or more fans 84, a power supply chamber inlet 74 and a power supply chamber outlet 72. Cool air enters the power supply chamber 60 via the power supply chamber inlet 74, collects heat from the power supply 62, and exits the power supply chamber 60 via the power supply chamber outlet 72. As air passes through each of the chambers 52, 56 and 60, the air may pass by hardware in the chamber, through hardware in the chamber, or both. Although FIG. 1 only shows one inlet and one outlet per chamber, any suitable number of inlets and/or outlets may be used.

The remainder of this disclosure describes embodiments in the context of a desktop computer. However, as mentioned above, the technique disclosed herein may be implemented in any suitable electronic device.

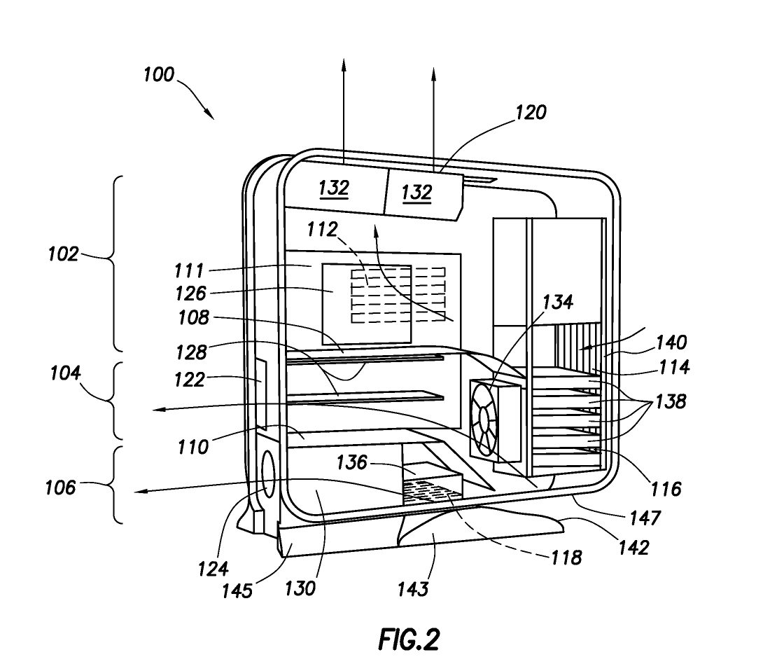

FIG. 2 shows an illustrative desktop computer implementing an embodiment of the invention. Specifically, FIG. 2 shows a computer chassis 100. The chassis 100 comprises a CPC chamber 102, a PCI chamber 104 and a power supply chamber 106. Divider 108 separates the CPC chamber 102 from the other chambers, while divider 110 separates the power supply chamber 106 from the other chambers. Both dividers 108 and 110 separate the PCI chamber 104 from the other chambers. The chassis 100 also comprises a hard drive frame 140 that stores a plurality of hard drives 138. The CPC chamber 102 comprises a CPC 126, while the PCI chamber 104 comprises PCI circuitry 128 and the power supply chamber 106 comprises a power supply 130. The CPC 126 and the PCI circuitry 128 are mated to a circuit board 111, such as a motherboard. A stand 142 comprising a foot member 143 and a riser 145 is connected to the back of bottom panel 147 of chassis 100 such that the remainder of the bottom panel 147 and chassis 100 extends in a cantilevered fashion over the foot member 143 allowing at least one centimeter of unobstructed space beneath bottom panel 147. In some embodiments, the riser 145 causes a bottom panel 147 of the chassis 100 to be at least 1 cm away from the nearest obstruction foot member 143. In some embodiments, the riser 145 causes the bottom panel 147 of the chassis 100 to be 4-5 cm away from foot member 143.

The CPC chamber 102 receives cool air from outside the chassis 100 via the side CPC chamber inlets 112. The CPC chamber 102 receives additional cool air from outside the chassis 100 via the anterior CPC chamber inlets 114. The PCI chamber 104 receives cool air from outside the chassis 100 via the PCI chamber inlets 116. The power supply chamber 106 receives cool air from outside the chassis 100 via the power supply chamber inlets 118, which are located on the base panel of the chassis 100.

Cool air provided to the CPC chamber 102 may be circulated through the CPC chamber 102 by one or more fans 132 disposed on a top surface of the chassis 100. The cool air collects heat from, and thereby cools, the CPC 126. The fans 132 draw the warmed air out of the CPC chamber 102 and expel the warm air via the CPC chamber outlets 120. Similarly, cool air may be circulated through the PCI chamber 104 by one or more fans 134. The cool air is moved past the hard drives 138 by such fans 134. The cool air collects heat from, and thereby cools, the PCI circuitry 128. The warmed air is expelled from the PCI chamber 104 via the PCI chamber outlet 122. Likewise, cool air may be circulated through the power supply chamber 106 by one or more fans 136 disposed on a bottom surface (i.e., on the base panel and adjacent to the air inlets 118) of the chassis 100. The cool air collects heat from, and thereby cools, the power supply 130. The warmed air is expelled from the power supply chamber 106 via the power supply chamber outlet 124. Air expelled via the outlet 124 may pass through the power supply 130, beside the power supply 130, or some combination thereof, depending on the type of power supply used. Stated in another way, as air passes through each of the chambers 102, 104, and 106, the air may pass by hardware in the chamber, through hardware in the chamber, or both.

FIG. 3 shows an external, three-dimensional, posterior view of another illustrative computer chassis 200. The chassis 200 comprises CPC chamber outlets 202-203, a PCI chamber outlet 204 and a power supply chamber outlet 206. Unlike the chassis 100 of FIG. 2, in which a CPC chamber outlet is positioned only on a top side of the chassis 100, the chassis 200 of FIG. 3 has a CPC chamber outlet 202 positioned on a posterior side of the chassis 200 in addition to a CPC chamber outlet 203 positioned on a top side of the chassis 200. The CPC chamber outlets 202-203 both enable warm air to be expelled from a CPC chamber within the chassis 200. The PCI chamber outlet 204 enables warm air to be expelled from a PCI chamber within the chassis 200. Similarly, the power supply chamber outlet 206 enables warm air to be expelled from a power supply chamber in the chassis 200. In some embodiments, depending on the presence and/or arrangement of fans within the computer chassis 200, some air outlets may serve as inlets, and/or some air inlets may serve as outlets.

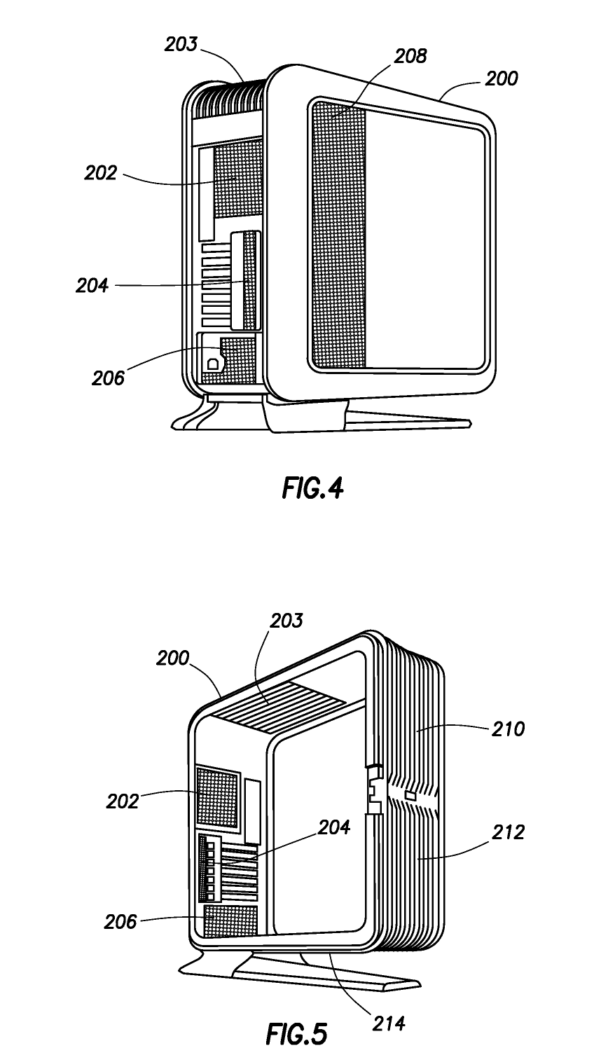

FIG. 4 shows the chassis 200 of FIG. 3 from a different angle. In addition to the CPC chamber outlets 202-203, the PCI chamber outlet 204 and the power supply chamber outlet 206, the chassis 200 further comprises a side inlet 208. Because the side inlet 208 almost spans the height of the chassis 200, the side inlet 208 enables cool air from outside the chassis 200 to enter a CPC chamber, a PCI chamber, a power supply chamber, two of the chambers simultaneously, or all three chambers simultaneously.

FIG. 5 shows a more detailed view of the chassis 200. The hardware contents of the chassis 200 are removed for clarity. Shown in the chassis 200 are the CPC chamber outlets 202-203, the PCI chamber outlet 204, the power supply chamber outlet 206, anterior CPC chamber inlets 210, anterior PCI chamber inlets 212 and powers supply chamber inlets 214. The anterior CPC chamber inlets 210 enable cool air to enter a CPC chamber of the chassis 200, while the CPC chamber outlets 202-203 enable warm air from the CPC chamber to exit the chassis 200. Similarly, the anterior PCI chamber inlets 212 enable cool air to enter a PCI chamber of the chassis 200, while the PCI chamber outlet 204 enables warm air from the PCI chamber to exit the chassis 200. Likewise, the power supply chamber inlets 214 enable cool air to enter a power supply chamber of the chassis 200, while the power supply chamber outlet 206 enables warm air from the power supply chamber to exit the chassis 200.

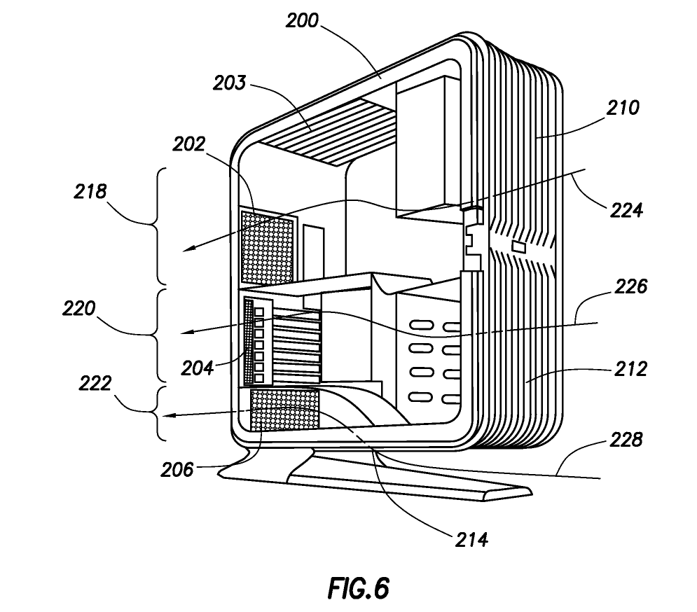

FIG. 6 shows a conceptual illustration of airflow through the chassis 200. Arrow 224 is indicative of cool air entering the CPC chamber 218 of the chassis 200 via the anterior CPC chamber inlets 210. The cool air is warmed within the CPC chamber 218 by circuitry (e.g., CPU) within the CPC chamber 218. The warm air is then expelled via the CPC chamber outlet 202. Warm air also may be expelled via the CPC chamber outlet 203. Arrow 226 is indicative of cool air entering the PCI chamber 220 of the chassis 200 via the anterior PCI chamber inlets 212. The cool air is warmed within the PCI chamber 220 by circuitry (e.g., PCI-based circuitry, graphics processors) within the PCI chamber 220. The warm air is then expelled via the PCI chamber outlet 204. Arrow 228 is indicative of cool air entering the power supply chamber 222 of the chassis 200 via the power supply chamber inlets 214. The cool air is warmed within the power supply chamber 222 by a power supply within the power supply chamber 222. The warm air is then expelled via the power supply chamber outlet 206.

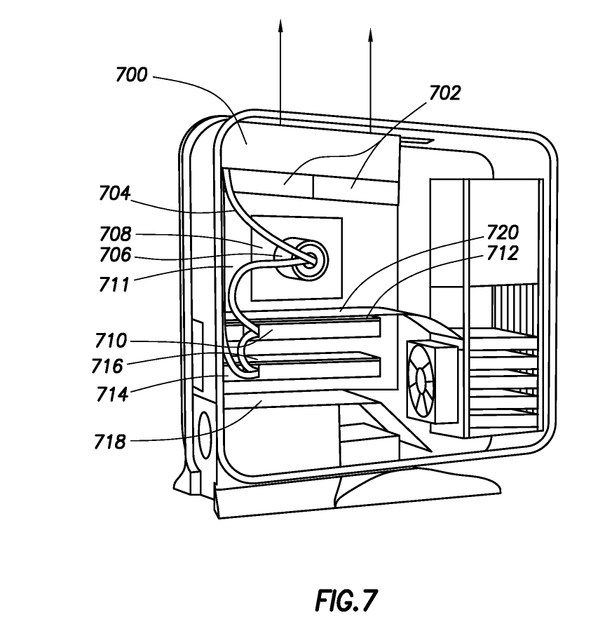

In some embodiments, chassis such as those described above may include liquid cooling systems in addition to the separate-chamber air cooling systems. FIG. 7 shows an illustrative chassis 698 comprising such a dual liquid cooling/air cooling system. The dual liquid cooling/air cooling system of chassis 698 may be implemented in a variety of chassis configurations, including, but not limited to, chassis 50, chassis 100 and chassis 200. As shown, the chassis 698 comprises dividers 718 and 720, which separate the chassis 698 into three chambers (as described above). In addition, the chassis 698 comprises a liquid cooling system that includes a radiator 700, fans 702 coupled to the radiator 700, tubing 704, CPU cooler 706, CPU 708, graphics card cooler 710, graphics card 712, graphics card cooler 714 and graphics card 716. The CPU 708, graphics card 712 and graphics card 716 mate to a circuit board 711, such as a motherboard. The tubing 704 is disposed inside the radiator 700, the CPU cooler 706 and the graphics card coolers 710 and 714.

In operation, liquid coolant (e.g., a solution consisting of 65% water and 35% glycol) is circulated through the tubing 704 by an electric pump (not specifically shown) in the CPU cooler 706. The CPU cooler 706 comprises any suitable mechanism for cooling the CPU 708 coupled to the CPU cooler 706. For example, the CPU cooler 706 may comprise the aforementioned pump, a coolant reservoir and a cold plate. The pump circulates the coolant throughout the tubing 704; the coolant reservoir replenishes any coolant lost due to permeability of the tubing 704 or other components; and the cold plate (e.g., having a fin structure) transfers heat from the CPU 708 to liquid coolant circulating through the tubing 704. The coolant passes through the CPU cooler 706 and collects heat generated by the CPU 708, thereby cooling the CPU 708.

The coolant then passes from the CPU cooler 706 to the graphics card cooler 710 via the tubing 704. The graphics card cooler 710 comprises any suitable fan-based assembly, such as a heat sink/fan combination device, for cooling the graphics card 712. For example, in some embodiments, the graphics card cooler 710 comprises a cold plate that cools a high-power-density component, like a graphics processor, using the liquid cooling system described above. The graphics card cooler also comprises a fan and heat sinks, heat pipes, etc. which together function to remove heat from the remaining components on the graphics card 712, such as RAM, power circuit devices, etc. The coolant passes through the graphics card cooler 710 and collects heat generated by the graphics card 712. In this way, the graphics card 712 is cooled.

The coolant then passes from the graphics card cooler 710 to the graphics card cooler 714 via the tubing 704. Like the graphics card cooler 710, the graphics card cooler 714 may comprise any suitable fan-based assembly (e.g., a device comprising a heat sink and fan) for cooling the graphics card 716 and, in some embodiments, may have an identical or substantially similar structure as that of the graphics card cooler 710. The coolant removes heat generated by the graphics card 716 and then moves to the radiator 700. The radiator 700 removes heat from the coolant and expels the heat from the chassis 698 (via, for example, the CPU chamber outlets 203 shown in FIG. 5). Expulsion of heat collected by the radiator 700 is enhanced by the fans 702, which push air out of the chassis 698.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A computer chassis comprising a plurality of chambers, each said chamber comprising:
a hardware group;
an air inlet exposed to air external to said chassis and dedicated to said chamber; and
an air outlet exposed to air external to said chassis and dedicated to said chamber;
wherein airflow between the air inlet and the air outlet cools said hardware group.

2. The computer chassis of claim 1, wherein said hardware group in a first said chamber comprises a central processing unit (CPU), said hardware group in a second said chamber comprises peripheral component interface (PCI)-based hardware, and said hardware group in a third said chamber comprises a power supply.

3. The computer chassis of claim 2, wherein said hardware group in said second chamber further comprises at least one hard drive.

4. The computer chassis of claim 1, wherein at least one said chamber further comprises at least one fan that is disposed between said air inlet and said air outlet.

5. The computer chassis of claim 1, wherein at least one said chamber shares a common wall with at least one adjacent chamber.

6. The computer chassis of claim 5, wherein said common wall is curved to facilitate airflow.

7. The computer chassis of claim 1, wherein at least one said chamber comprises an air outlet disposed on a top surface of said computer chassis.

8. The computer chassis of claim 1, wherein said air inlets for at least two of said chambers that are adjacent are formed by a continuous opening in the chassis wall.

9. The computer chassis of claim 1 further comprising:
at least one fan corresponding to a first said chamber;
tubing coupled to the hardware group in said first chamber and comprising liquid coolant; and
a radiator coupled with said tubing.

10. The computer chassis of claim 9, wherein said tubing passes from said first chamber to a second said chamber.

11. The computer chassis of claim 1 further comprising a foot member and a riser coupled to the foot member, the riser connected to a back of a bottom panel of the computer chassis such that a remainder of the bottom panel and the computer chassis extends in a cantilevered fashion over the foot member.

12. An electronic system, comprising:
central processing circuitry (CPC);
peripheral component interface (PCI) circuitry; and
a power supply;
wherein the CPC, the PCI circuitry and the power supply correspond to dedicated ventilation systems that cause the CPC, the PCI circuitry and the power supply to be cooled separately from each other.

13. The electronic system of claim 12, wherein a chamber comprising the CPC also comprises multiple air inlets dedicated to said chamber, at least one of said multiple air inlets disposed on a top surface of a chassis of the electronic system.

14. The electronic system of claim 12, wherein a first chamber comprises the CPC and a second chamber comprises the PCI, said first and second chambers share a common air inlet by which the CPC and PCI are ventilated.

15. The electronic system of claim 12, wherein:
a first chamber comprises the CPC and a second chamber comprises the PCI;
tubing couples to the CPC in said first chamber and comprises liquid coolant; and
said tubing passes from the first chamber to the second chamber and couples to the PCI.
